(19) United States
(12) Patent Application Publication
(10) Pub. No.: US 2004/0134075 A1
(43) Pub. Date: Jul. 15, 2004

(54) Folding knife

(76) Inventor: Hui-Tung Chu, Luchou City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/342,611

(22) Filed: Jan. 15, 2003

(51) Int. Cl. B26B 1/04

(52) U.S. Cl. 30/161; 30/160

(57) ABSTRACT

A folding knife includes a handle having a first handle half and a second handle half coupled together to define a slot on a longitudinal edge of the handle. A blade is pivotally connected to the handle and rotatable relative to the handle between a folded position and an unfolded position. A slider is movable in an elongated groove of the second handle half. The slider is spring-loaded and tends to be moved towards a front end of the handle, and a slider control is provided for moving the slider away from the front end. Furthermore, the blade has a cutout and the elongated groove of the second handle half is arranged so that the slider may be moved into the cutout when the blade is in its unfolded position, thereby preventing the blade from rotation and hence retaining the blade in this unfolded position.

### BACKGROUND OF THE INVENTION

1. Field of the Invention

The present invention relates to a folding knife and, more particularly, to a folding knife with high safety which is easy to be operated.

2. Description of Related Art

A prior art folding knife is shown in FIGS. 7 and 8. The folding knife includes a pair of coupled handle halves (60, 70) and a blade (80) pivotally connected to the handle halves (60, 70). The blade (80), with a sharp edge (81) as usual, is additionally provided with a boss (82) used for turning out the blade (80) and an oblique end surface (83), which is clearly shown in FIG. 8.

As can also be seen in FIG. 8, disposed between the two handle halves (60, 70) is a leaf spring (61) that has a normally raised distal end (62) in correspondence to the oblique end surface (83) of the blade (80). As soon as the blade (80) is turned out of the handle halves (60, 70) to a predetermined position suitable for use, the distal end (62) of the leaf spring (61) rises and engages with the oblique end surface (83), thus retaining the blade (80) in this position.

However, the conventional folding knife has a disadvantage that the blade (80) in use may be accidentally turned back towards the handle halves (60, 70) and brings the user into a risk of injury. This often happens when the distal end (62) of the leaf spring (61) has not risen properly. It is also found that the folding knife is not easy to be operated because it is necessary for the user to depress the distal end (83) of the leaf spring (61) by using a fingernail to take the blade (80) back into a spacing between the handle halves (60, 70).

Therefore, it is an objective of the invention to provide a folding knife to mitigate and/or obviate the aforementioned problems.

### SUMMARY OF THE INVENTION

The object of the present invention is to provide a folding knife which has high safety for use.

Another object of the present invention is to provide a folding knife which is easy to be operated.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a preferred embodiment of a folding knife in accordance with the present invention;

FIG. 2 is another exploded perspective view of the folding knife of FIG. 1;

FIG. 3 is a perspective view of some parts included in the folding knife of FIG. 1;

FIG. 4 is a partial cross sectional view of the folding knife of FIG. 1;

FIG. 5 is a top view of the folding knife of FIG. 1, showing a blade being turned out;

FIG. 6 is a top view of the folding knife of FIG. 1, showing the blade turned to its unfolded position;

FIG. 7 is a top view of a prior art folding knife; and

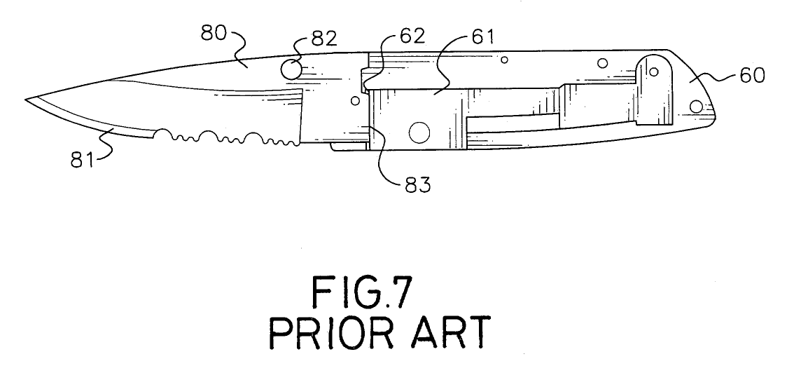

FIG. 8 is a front view of the prior art folding knife of FIG. 8.

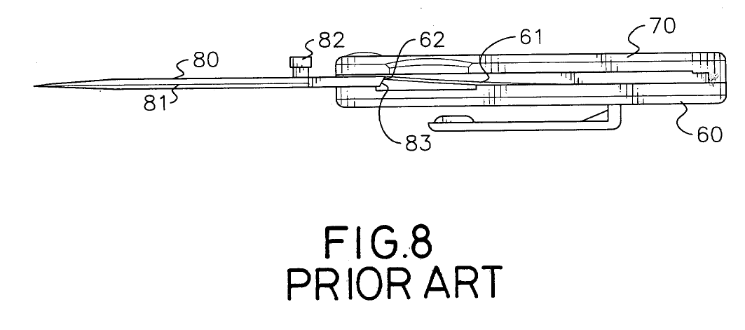

### DETAILED DESCRIPTION OF THE PREFERRED EMBODIMENT

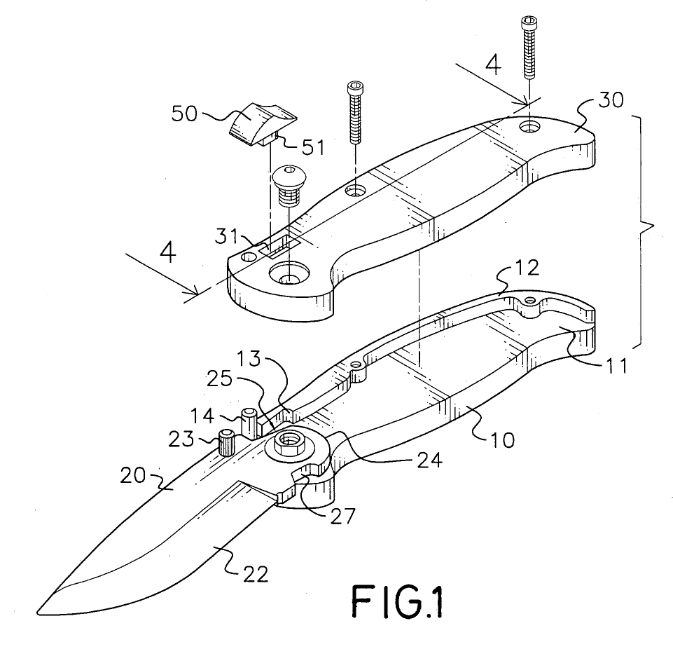

Referring to FIG. 1, there is shown a preferred embodiment of a folding knife in accordance with the present invention. The folding knife includes a handle having a first handle half (10) and a second handle half (30) that are coupled together, such as by screws.

The first handle half (10) has an elongated protrusion (12) extending along a longitudinal edge thereof, so as to define a slot (11) on an opposite longitudinal edge of the handle after the second handle half (30) has been coupled to the first handle half (10) at the elongated protrusion (12). The first handle half (10) is preferably formed with a stop (14) in place thereon.

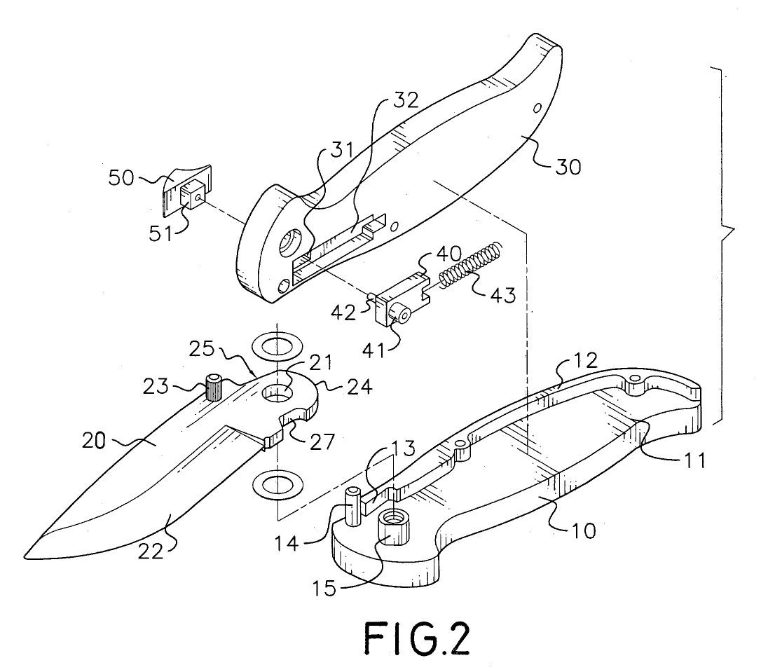

The inventive folding knife further includes a blade (20) formed with a sharp edge (22) and an arced end (24). Particularly, the blade (20) has a cutout (25) and a notch (27) both defined adjacent to the arced end (24) and opposite to each other. Moreover, the blade (20) is pivotally connected at the arced end (24) to a front end of the handle, such as by means of an apertured post (15) that extends from the first hand half (10) into a hole (21) of the blade (20), as best shown in FIG. 2.

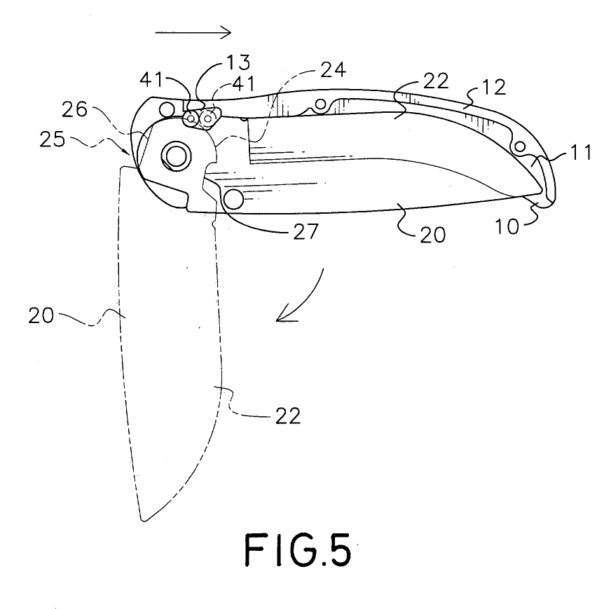

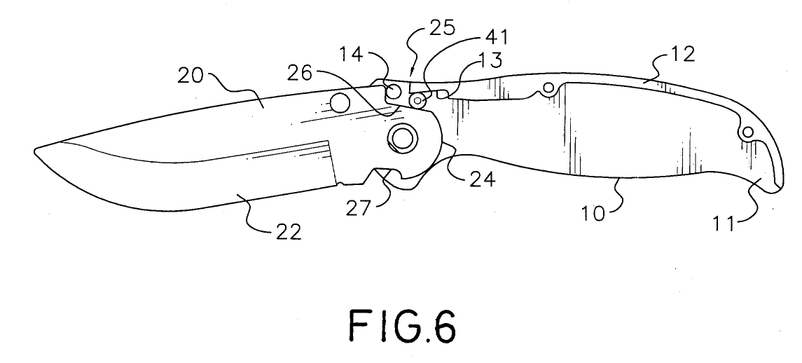

The blade (20) is then rotatable relative to the handle between a folded position, in which the sharp edge (22) of the blade (20) is received in the slot (11) of the handle, as shown in FIG. 5, and an unfolded position, in which the sharp edge (22) of the blade (20) is kept out of the slot (11) of the handle, as shown in FIG. 6.

In the highly preferred embodiment as illustrated, the first handle half (10) is formed with the stop (14) which is engagable with the blade (20) when the blade (20) is fully unfolded, thereby defining the unfolded position of blade (20).

Referring still to FIG. 1 and particularly to FIG. 2, the second handle half (30) has an oblong through-hole (31) in communication with an elongated groove (32), which is defined in an inner face of the second half (30), as best shown in FIG. 2. The groove (32) is provided for receiving a slider (40) therein.

The slider (40) is movable in the elongated groove (32), and has a first post (41) extending towards the first handle half (10) and a second post (42) extending into the oblong through-hole (31) of the second handle half (30). Additionally, the slider (40) is spring-loaded, such as by a helical spring (43) compressed between the slider (40) and a rear end wall of the groove (32), in such a manner that the slider (40) tends to be moved forward towards the front end of the handle.

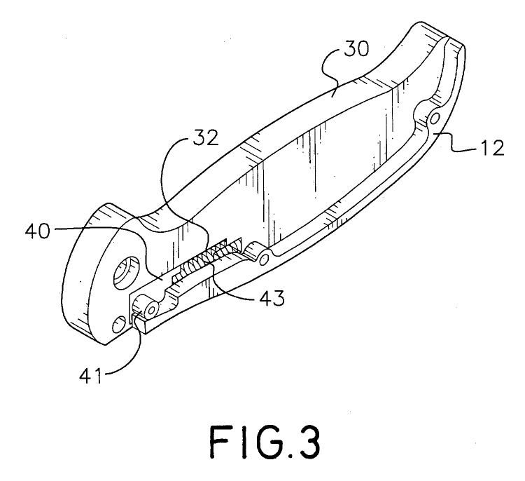

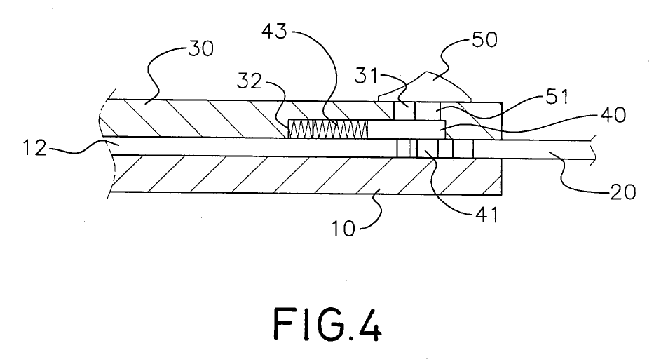

As clearly shown in FIGS. 3 and 4, the elongated groove (32) of the second handle half (30) is partially covered by the elongated protrusion (12) of the first handle half (10), in order to prevent the slider (40) as well as the spring (43) from escaping from the groove (32).

In the inventive folding knife, there is further provided a slider control (50) for moving the slider (40) backward, i.e. away from the front end of the handle. To this end, the slider control (50) has a stub (51) extending through the oblong through-hole (31) and connected to the slider (40), thereby allowing the slider control (50) to move the slider (40) away from the front end of the handle.

Referring to FIGS. 5 and 6, the blade (20) can be taken out of the handle simple by holding the handle while pushing a boss (23) of the blade (20) in an angular direction as designated by a curved arrow in FIG. 5.

Initially, as the blade is being turned relative to the handle, a part of outer edge which defines the notch (27) of the blade (20) will push the slider (40), or to be precise, the first post (41) of the slider (41) backward away from the front end of the handle, i.e. in a direction as designated by a straight arrow in FIG. 5. The first post (41) then slides over the arced end (24) of the blade (20) as a result of the relative rotation of the blade (20).

As can be seen in FIG. 6, the relative rotation of the blade (20) is continued until the stop (14) of the first handle half (11) is engaged with the blade (20), which now reaches its unfolded position. It is in the unfolded position that the first post (41) of the spring-loaded slider (40) is moved into the cutout (25) and engaged with an outer edge (26) of the blade (20), thus preventing the blade (20) from rotation and therefore retaining the blade (20) in the unfolded position.

The blade (20) can be taken back into the handle by moving the slider control (50) backward before turning the blade (20) relative to the handle. Meanwhile, the first post (41) of the slider (40) slides over the arced end (24) once more until the blade (20) reaches its folded position, in which the first post (41) of the spring-loaded slider (40) is moved back into the notch (27) and retains the blade (20) in the folded position.

From the above description, it is apparent that this invention has the following advantages:

1. being safe in use:

Because the blade (20) can be retained securely in its unfolded position, the inventive knife may be used in safety without the risk of accidentally turning back the blade (20) towards the handle;

2. being easy to be operated:

Because no leaf blade (20) is required to be pressed, the blade (20) can easily be taken out even without moving the slider control (50).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A folding knife comprising:
a handle having a front end and a rear end, said handle being formed with a first handle half (10) and second handle half (30) coupled together and configured to define a slot (11) on a longitudinal edge of said handle, said second handle half (30) having an elongated groove (32) defined in an inner face thereof;
a blade (20) having a sharp edge (22) and an arced end (24), said blade (20) being pivotally connected at said arced end (24) to a front end of said handle;
said blade (20) being rotatable relative to said handle between a folded position in which said sharp edge (22) of said blade (20) is received in said slot (11) of said handle and an unfolded position in which said sharp edge (22) of said blade (20) is kept out of said slot (11) of said handle;
a slider (40) movable in said elongated groove (32) of said second handle half (30), said slider (40) being spring-loaded and tending to be moved towards said front end of said handle;
a slider control (50) for moving said slider (40) away from said front end of said handle; and
wherein said blade (20) has a cutout (25) adjacent to said arced end (24) and said elongated groove (32) of said second handle half (30) is arranged so that said slider (40) may be moved into said cutout (25) when said blade (20) is in said unfolded position, thereby preventing said blade (20) from rotation and hence retaining said blade (20) in said unfolded position.

2. The folding knife as claimed in claim 1, wherein said first handle half (10) has an elongated protrusion (12) extending along a longitudinal edge thereof, and wherein said second handle half (30) is coupled to said first handle half (l0) at said elongated protrusion (12).

3. The folding knife as claimed in claim 1, wherein said elongated groove (32) of said second handle half (30) is partially covered by said elongated protrusion (12) of said first handle half (10) in order to prevent said slider (40) from escaping from said elongated groove (32).

4. The folding knife as claimed in claim 1, wherein said first handle half (10) is formed with a stop (14) engagable with said blade (20) when said blade (20) is fully unfolded, thereby defining said unfolded position of said blade (20).

5. The folding knife as claimed in claim 1, wherein said second handle half (30) further has an oblong through-hole (31) in communication with said elongated groove (32), and wherein said slider control (50) has a stub (51) extending through said oblong through-hole (31) and connected to said slider (40), thereby allowing said slider control (50) to move said slider (40) away from said front end of said handle.

6. The folding knife as claimed in claim 1, wherein said blade (20) further has a notch (27) adjacent to said arced end (24) and opposite to said cutout (25), and wherein said slider (40) may be moved into said notch (27) when said blade (20) is in said folded position, thereby retaining said blade (20) in said unfolded position.
